(19) United States
(12) Patent Application Publication
(10) Pub. No.: US 2014/0122284 A1
(43) Pub. Date: May 1, 2014

(54) ON-LINE BIDDING SYSTEM & METHOD

(71) Applicant: Matthew Bockh, St. Petersburg, FL (US)

(72) Inventor: Mat Bockh, St. Petersburg, FL (US)

(21) Appl. No.: 13/661,458

(22) Filed: Oct. 26, 2012

(51) Int. Cl. G06Q 30/08

(52) U.S. Cl. CPC G06Q 30/08
USPC 705/26.3

(57) ABSTRACT

A system and method (10) for online bidding wherein a seller (16) creates sale terms including a start or maximum sale price (22) and an end or minimum sale price (24) and a length of time (20) for each particular item or service (30) they want to sell. The sale of each item or service (30) items begins at the start price (22) and drops steadily throughout the length of time of the auction (20) until the item or service reaches the end price (24). A purchaser or bidder (12) has full access to the sale terms provided by the seller (16) including the start price (22), the end price (24), and the time length of the sale (20). A bidder (12) can bid based on either price or time.

### CROSS-REFERENCE TO RELATED APPLICATIONS

This application claims priority from U.S. Provisional Application Ser. No. 61/551,630 titled “ON-LINE BIDDING SYSTEM & METHOD” which was filed on Oct. 26, 2011, which is incorporated fully herein by reference.

### TECHNICAL FIELD

The present invention relates to online bidding and more particularly, relates to an on-line internet based system and method that incorporates bid price and/or time lapse into the final sale price determination.

### BACKGROUND INFORMATION

Online (internet based) bidding for the purchase of various products or services has become increasingly popular through various websites that enable purchasers to bid for items or services. These prior art online bidding systems allow purchasers to choose a price they are willing to pay and may allow sellers to set a starting price, to set a minimum price or reserve at which they are willing to sell, and to set a time limit for the length of time that the item will be available. The current methods and systems allow for many possible variations in the online bidding process. However, these methods and systems are also lacking in allowing full synchronization of the expectations of both buyers and sellers.

Therefore, what is needed is an online bidding method and system that enables a seller to set a minimum price, a maximum price, and a time limit for the sale of a particular item or service. The system and method should allow a bidder to know the sellers start price or maximum price, the end price or minimum price and the time limit of the sale. Based on this data, the bidder places their bid by either time or price. Multiple bidders can bid on one item and the winning bidder will be the first to bid at the time their bid occurs on the time line created by the seller's price and time input.

### SUMMARY

The present invention features a novel system and method for bidding for the purchase of an item(s) or service(s). The seller creates sale terms including a start price and/or maximum sale price, and an end price and/or a minimum sale price and a length of time the bidding process will be open for each particular item or service they want to sell. The start price should be greater than or equal to the end price. The sale of each item or service begins at the start price and drops steadily throughout the length of time of the auction until the item reaches the end price. A purchaser or bidder has full access to the sale terms provided by the seller, including the start price, the end price, and the time length of the sale.

Based on the sale terms, the bidder can place a bid that involves less risk and allows for instant purchase, by paying the start price at the beginning of the auction. The bidder can incur maximum risk and wait out the entire auction by bidding the end price and waiting until the conclusion of the auction. The bidder can also bid any price in-between the maximum price and the minimum price. As time elapses, the price will decrease at a predetermined rate from the start price to the end price. The bidder can bid based on a certain price, which causes a bidder to know the exact moment in time when their bid will become effective. Alternatively, the bidder can bid based on a certain time, which causes a bidder to also know the exact price they will pay at a particular time.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a schematic view of the bidding system according to one embodiment of the present invention;

FIG. 2 is a graphical depiction of the bidding model according to one embodiment of the present invention; and

FIG. 3 is a flow chart of the bidding method according to one embodiment of the present invention.

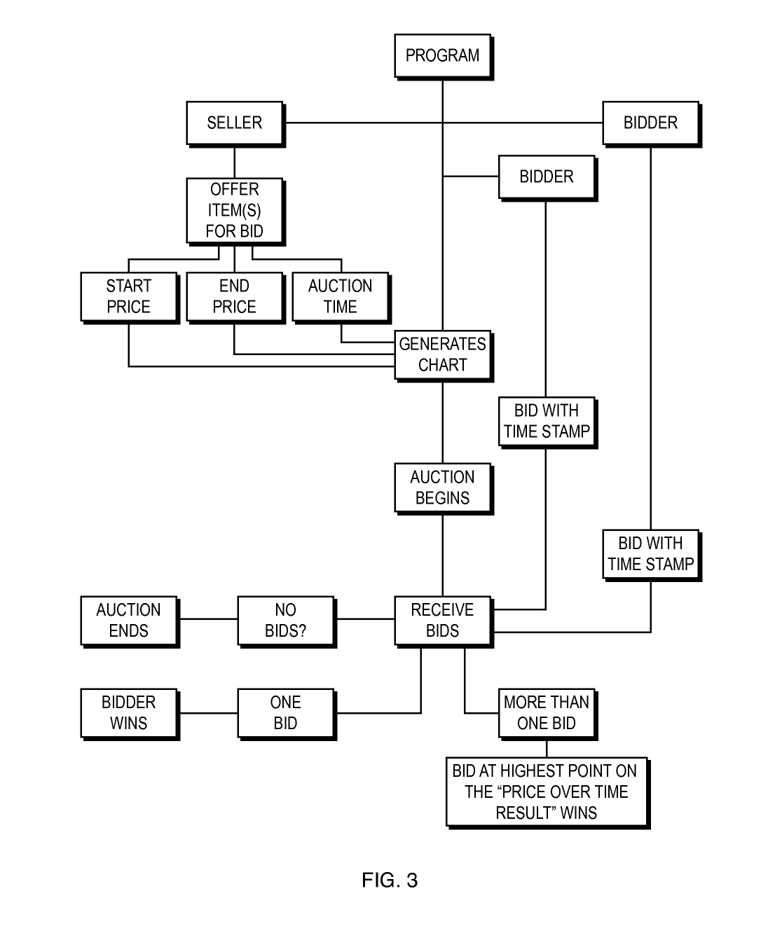

### DETAILED DESCRIPTION OF THE PREFERRED EMBODIMENTS

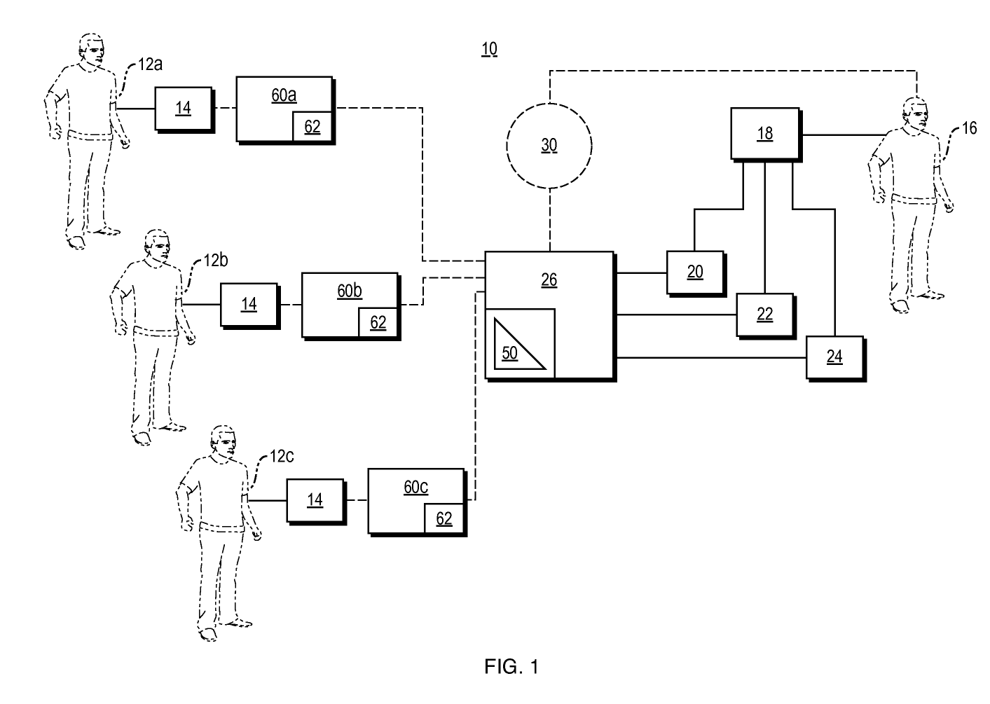

The present invention features a system and method 10, FIG. 1, of bidding on item or items or services 30 via the internet and/or other electronic means, using an internet or other wireless connected capable device 14, such as a personal computer, a laptop, a mobile device, a telephone, tablet or any other device able to connect to the internet, cell phone system or the like. The invention allows one or more bidders 12 who have an internet or other wireless or wired communication capable device 14 to bid to purchase one or more items or services 30 from a seller 16 who also has an internet or other wireless or wired communication capable device 18.

The seller 16 has one or more items or services 30 that they wish to sell. The seller 16, utilizing the system and method of the present invention enters a maximum or start price 24 at which they are willing to sell the item 30 into a computer software program 26 typically running as a web based application on a server, however the use of a web based application on a server is not intended to be a limitation of the present invention. The seller 16 also enters a minimum end price 22 at which they are willing to sell the item 30 into the program 26. The start price 24 is always equal to or higher than the end price 22. Preferably, the start price should be higher than the end price.

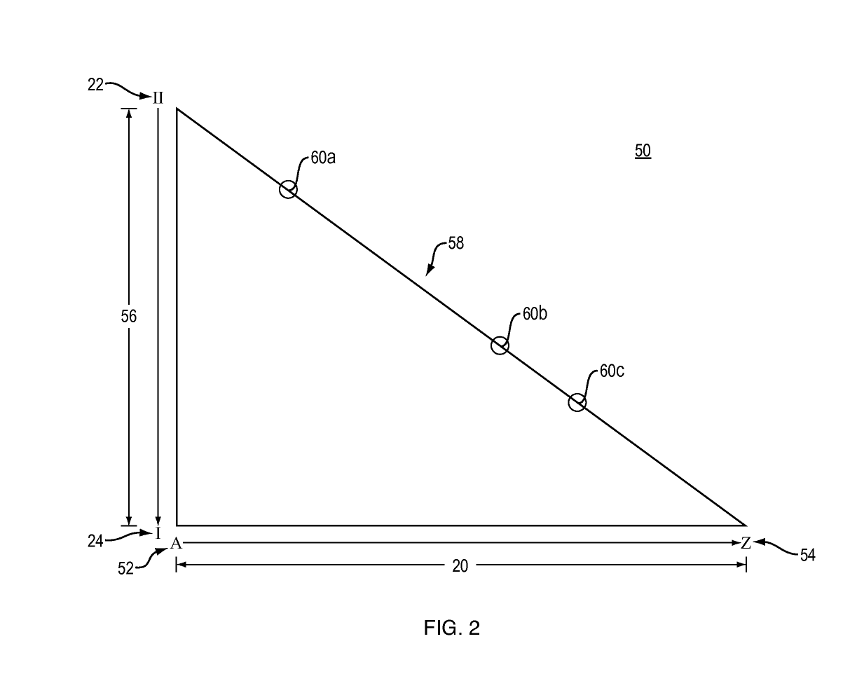

The seller 16 then enters an amount of time 20 for which an auction will run for the item or service 30 into the program 26. The amount of time 20 can be any incremental amount of time, such as a particular number of minutes, hours or days. The amount of time 20 is a fixed amount of time. The fixed amount of time 20 that an item or service 30 is available for sale is variable and may be controlled by entering in a starting time 52, an ending time 54, and/or the total amount of time 20 for each auction. The amount of time 20 that an item or service is up for sale or up for auction is generally a fixed amount of time. However it is contemplated and within the scope of the present invention that a seller 16 may be able to extend the length of time that the item or service 30 is available for sale by adjusting or amending the ending time 54. Extension of the amount of time 20 can occur at any time during the sale or at a time after the conclusion of the sale. Extension of the amount of time 20 may also be combined with a change in the price of the item or service 30. The program 26 generates a representation of the seller's parameters (maximum price 24, minimum price 22 and amount of time 20) in the form of a graph or chart 50, FIG. 2.

The graph or chart 50 graphically displays the selling price 56 of the item or service 30 starting with the maximum price 22 and declining down to the minimum price 24 along the Y axis; and displays an amount of time 20 of the sale or auction along the X axis, starting from a start time 52 to an end time 54. A definitive or exact price over time result line 58 is created. The price over time result line 58 shows the exact price that the item or service 30 will cost at any given time during the auction or bidding process. The price over time result line 58 details the steady decline in the price of the item over the time period 20 of the auction.

Each bidder 12 will preferably have access to view the chart 50 and will be able to determine the price they are willing to pay for the item or service 30 taking into consideration that they can be outbid (that is someone can bid a higher price at an earlier time). For example, if a bidder 12 wants the item or service 30 and is willing to pay the maximum price 22, the bidder 12 can bid the maximum price 22 at the start time 52 to essentially ensure that they will purchase (or are most likely to purchase) the item or service 30. If the bidder 12 is only wiling to pay the minimum price 24, then the bidder 12 can bid the minimum price 24 and the bid will only become effective at or just prior to the end time 54. The bidder can also bid any amount in-between the maximum price 22 and the minimum price 24. The bid will become effective at the time determined by the price over time result line 58 that corresponds with the dollar or price amount that the bidder desires to bid.

The bidder 12 can also bid on a time basis instead of a price basis. In bidding on a time basis, the bidder 12 would bid based on time, and the bid could be for the start time 52, the end time 54, or any increment of time in-between the start time 52 and the end time 54. The time bid would be used in conjunction with the price over time result line 58 in order to determine the monetary bid for the item or service 30 at that predetermined time that the bidder has selected. In this way, a bidder would locate the time that they want to bid on the X axis of the representative graph 50. They would follow this time up to the price over time result line 58 and then follow horizontally to the Y axis to determine the monetary amount of the bid.

For example, if a bidder were to bid at the end time 54, then the bid would be for the minimum or end price 24. A bidder 12 may also have the ability to change their bid; that is to either to change the time of their bid or the price of their bid, at any point prior to the end of the auction.

The preferred method of bidding allows for a plurality of potential bidders 12a, 12b, etc. The program 26 collects all bids as they occur. All of the bids 60a, 60b, etc. may appear on the graph 50 and therefore be visible to all other bidders. All bids must fall somewhere on the price over time result line 58. The winning bid is the one with the highest bid and earliest time slot, i.e. the one that falls on the highest point along the price over time result line 58. Once the auction starts, bidding proceeds until a winning bid is placed (the corresponding bid price/time occurs) or until the end time 54 occurs. By way of example, in the graph shown in FIG. 2, assuming no other bids are placed, the winning bid would be shown as bid 60a.

The amount of time 20 of the auction or bidding process can be extended during the auction or following the conclusion of the auction, with or without a change in the price of the item 30. A winning bid will be either a monetary amount that corresponds to the exact amount of time using the price over time result line 58 or a time bid once that time occurs. In the preferred embodiment, all of the bidders 12 can see all of the bids 60.

Each bid 60 features a time stamp 62. The time stamp 62 is the exact time a particular bidder 12 placed his or her bid 60. The time stamp 62 is preferably accurate to within 1/100^{th} of a second. This accuracy allows each bid to have a unique time stamp and allows each bid to be placed into an order. A first bid 60a from a first bidder 12a will have a different time stamp that a first bid 60b from a second bidder 12b. The time stamp determines the priority of bids in the case of 2 bidders would have been the same monetary amount or the same time. The highest monetary bid or earliest time bid, whichever is highest along the price over time result line 58 is the winning bid.

At the close of the auction, the system and method of the present invention will determine if there is a winning bidder; notify the winning bidder of his or her winning bid; arrange for the winning bidder to provide payment in the amount of his or her winning bid; and notify the seller of the identity of the winning bidder so that the seller may arrange to forward the purchased item or service to the winning bidder upon receipt of appropriate payment. Such post-auction processing is well known in the art and intentionally not described in greater detail.

The item or service 30 can be any type of item or service. For example, the item may be a physical item, such as a car, a bicycle, or any other physical item. The item (service) can also be a service, a coupon, a discount, etc. There can be one singular item for sale or there could be multiples of the items or services for sale. For example, the item for auction or bid may be a discount coupon for a particular restaurant in which case the seller 16 may say there are 25 such coupons available. Preferably, the auction should indicate to the bidders the exact number of items for sale.

Although the invention is described in a preferred embodiment that features internet or other wireless or wired communication capable device 18, it is contemplated and within the scope of the present invention that the system and method of the invention could be implemented without the use of the internet, either though such application as the use of hard wired telephone bidding or via live personal bidding or any other similar process. In addition, although the present invention may use the term “item” in the context of a product for sale by a user, this term is not limited to a tangible item that may include tangible items, services, discounts for products or services or the like.

The present invention features a unique bidding system and method that incorporates the use of both monetary bids and time bids into determinations of which bidder will be the winning bidder. The auction format features a start price for an item or service and an end price for the item or service, and the auction runs for a set amount of time, with the item price declining at a steady rate throughout the auction. Bidders can bid based on a particular price, which becomes affective at a particular time or bidders can bid based on a particular time which translates effectively into a particular price that the item or service will be priced at a predetermined time.

It is important to note that the present invention is not intended to be limited to a system or method which must satisfy one or more or all of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A system of bidding for the purchase of an item or service from a seller having one or more items or services to sell, wherein said seller pre-determines a start price for said one or more items or services, an end price for said one or more items or services, and an amount of time to conduct an auction, said system comprising:
a computer software program for instructing a programmable computer to implement a method of controlling the processing of data, wherein the computer software program is configured for receiving, from said seller, seller information comprising said pre-determined start price for said one or more items, said end price for said one or more items, and said amount of time to conduct said auction, wherein said computer software program is responsive to said seller information received from said seller for creating a visual representation showing said start price, said end price, and said amount of time with a start time and an end time, wherein said computer software program additionally creates a result over time line graphical representation that shows pricing of said item or service at any given time during said auction; and
one or more bidders, wherein said one or more bidders have access to said result over time line graphical representation and wherein said one or more bidders can bid to purchase said item or service by entering a bid value that corresponds to a point along said result over time line corresponding to a time bid or a monetary bid, and wherein said computer software program is configured for receiving said bid value from each of said one or more bidders and responsive to received bid value information from each of said one or more bidders and said seller information received from said seller, for determining if said one or more bidders has successfully bid for and acquired said item or service for sale by said seller, and for notifying said successful bidder of the successful purchase of the item or service for sale by the seller.

2. The system of claim 1, wherein said bidder and said seller utilize the internet and an internet capable device selected from the group consisting of: a personal computer, a laptop, a mobile device, and a telephone.

3. The system of claim 1, wherein said start price determined by said seller is the maximum sale price and wherein said end price determined by said seller is the minimum sale price, and wherein said start price is higher than said end price.

4. The system of claim 1, wherein said amount of time to conduct said auction is a fixed incremental amount of time, such as a fixed number of minutes, a fixed number of hours or a fixed number of days.

5. The system of claim 1, wherein the amount of time to conduct the auction includes the starting time, the ending time, and the total amount of time for each auction.

6. The system of claim 1, wherein said result over time line graphical representation displays on a Y axis of said graphical representation monetary values starting with the maximum price and declining down to the minimum price and on a X axis of said graphical representation said amount of time starting from the start time and declining down to the end time, and will wherein said result over time line graphical representation is represented by a generally linear line.

7. The system of claim 1, wherein a bid from said one or more bidders becomes effective at the time determined by the price over time result line, wherein a winning bidder is the bidder whose bid falls on a highest point along the price over time result line and wherein a bidder with an earliest bid effective time or the highest price wins said auction.

8. The system of claim 1, wherein said one or more bidders can change their bid, either by changing a time of their bid or a monetary price of their bid at any point prior to said end time of the auction or prior to placement of a winning bid on said auction by another bidder.

9. The system of claim 1, wherein each said time bid or said monetary bid by said one or more bidders appears on said result over time line graphical representation and wherein all of said one or more bidders can see bids of all other bidders as they occur.

10. The system of claim 1, wherein said seller can extend the amount of time for said auction during the auction or following conclusion of the auction, wherein said extension of the amount of time can occur with or without a change in the maximum or minimum sale price of the item.

11. The system of claim 1, wherein each bid by said one or more bidders includes a time stamp, wherein said time stamps is the exact time a bidder has placed a bid.

12. The system of claim 11, wherein said time stamp is accurate to within 1/100^{th} of a second.

13. The system of claim 11, wherein said time stamp determines a priority of bids when two or more bidders place an exact time bid or an exact monetary bid.

14. A method of auctioning an item, said method comprising the acts of:
creating an item or service auction profile by a seller, said auction profile including an identification of an item or service for auction, a start or maximum price for said item or service, an end or minimum price for said item or service, and an amount of time to conduct an auction;
receiving said auction profile by a computer software program, said computer software program configured for instructing a programmable computer to implement a method of controlling the processing of data, wherein the computer software program is responsive to said received auction profile, for creating a visual representation showing said start price, said end price, and said amount of time with a start time and an end time, wherein said visual representation creates a result over time line graphical representation that shows pricing of said item at any given time during said auction;
starting, by said computer software program, said auction at said start time; and
said computer software program allowing one or more bidders to place a monetary bid or a time bid for said item or service, wherein said monetary bid or said time bid corresponds to a point along said result over time line graphical representation, wherein all bids by said one or more bidders are visible on said result over time line graphical representation, for determining if said one or more bidders has successfully bid for and acquired said item or service for sale by said seller, and for notifying said successful bidder of the successful purchase of the item or service for sale by the seller.

15. The method of claim 14, wherein said start price determined by said seller is the maximum sale price and wherein said end price determined by said seller is the minimum sale price, wherein said start price is higher than said end price.

16. The method of claim 14, wherein said result over time line graphical representation displays on a Y axis of said graphical representation an amount of money starting with the maximum price and declining down to the minimum price and an X axis of said graphical representation with an amount of time starting from the start time and declining down to the end time, wherein said result over time line graphical representation is represented by a generally linear line.

17. The method of claim 14, wherein a bid from said one or more bidders becomes effective at the time determined by the price over time result line, wherein a winning bidder is the bidder whose bid falls on a highest point along the price over time result line and wherein a bidder with the earliest time or the highest price wins said auction.

18. The method of claim 14, wherein said time bid or said monetary bid appear on said result over time line graphical representation and wherein all of said one or more bidders can see bids of all other bidders as they occur.

19. The method of claim 14, wherein each bid by said one or more bidders includes a time stamp, wherein said time stamps is the exact time a bidder has placed a bid, wherein said time stamp is accurate to within 1/100^{th} of a second.

20. The method of claim 19, wherein said time stamp determines a priority of bids when two or more bidders place an exact time bid or an exact monetary bid.
